(19) United States
(12) Patent Application Publication
(10) Pub. No.: US 2003/0098774 A1
(43) Pub. Date: May 29, 2003

(54) Security apparatus

(76) Inventor: Todd E. Chornenky, Bethel Park, PA (US)

Correspondence Address: David C. Hanson, 700 Koppers Building, 436 Seventh Avenue, Pittsburgh, PA, 15219-1818, US

(21) Appl. No.: 09/813,744

(22) Filed: Mar. 21, 2001

Related U.S. Application Data
(60) Provisional application No. 60/191,068, filed on Mar. 21, 2000.
(60) Provisional application No. 60/197,169, filed on Apr. 14, 2000.

(51) Int. Cl. H04Q 1/00; G05B 19/00

(52) U.S. Cl. 340/5.1

(57) ABSTRACT

The present invention is a security apparatus (10) use in situations requiring authorized access. The security apparatus (10) includes a validator controller (12) and a data transmitter (14). The validator controller (12) includes a validator status actuator (16) in communication with a validator receiver (18) via a validator logic circuit (20). The validator status actuator (16) is configured to process and perform actions based upon data signals (22) received by the validator receiver (18). The data transmitter (14), which is in contact with a human nail (24), transmits the data signal (22) to the validator controller (12).

### CROSS-REFERENCE TO RELATED APPLICATION

This patent application claims the benefit of U.S. Provisional Patent Application Serial No. 60/191,068, filed Mar. 21, 2000 and U.S. Provisional Patent Application Serial No. 60/197,169 filed Apr. 14, 2000.

### BACKGROUND OF THE INVENTION

1. Field of the Invention

The present invention relates generally to security devices and, in particular, to security devices utilizing human nail characteristics for validation.

2. Description of the Prior Art

Throughout the world, security systems are used for various purposes, including: locking and unlocking mechanisms, enabling and disabling events, allowing and disallowing access, etc. All of these security device functions require some type of validation method or device to distinguish a valid user from an invalid user. For example, U.S. Pat. No. 4,196,347 to Hadley discloses a security system that uses a radiation signal emanating from a user's key to unlock a door. In addition, a magnetic field, as opposed to an electrical signal, can be used in the authorization process, as demonstrated in U.S. Pat. No. 5,016,376 to Pugh. Similarly, U.S. Pat. No. 4,354,189 to Lemelson is directed to a switch and lock activating system wherein the user wears a finger ring that contains a code, such that when the user places the ring near a validation device, the lock unlocks or the door opens. A common drawback to these types of systems is the ease of obtaining the validating device. If the key or ring is misplaced or stolen, the finder or thief is then able to access or unlock the lock without further validation.

In a recent push towards firearm control and safety, many governments have instituted gun safety programs, resulting in gun “locking” patents, both in the United States and abroad. These inventions prevent a gun from being operated by accident or by an unauthorized user. For example, U.S. Pat. No. 4,488,370 to Lemelson and U.S. Pat. No. 5,461,812 to Bennett both describe weapon control systems that use an electrical device, worn on the finger or wrist of a user, in combination with a validation device, to unlock the trigger mechanism of a gun. U.S. Pat. No. 5,062,232 to Eppler is directed to a safety device for firearms wherein the user wears a glove containing a device that emits a code which, when validated by a gun detector, permits the gun to be fired. As with the general security devices discussed above, using rings, gloves and other externally worn devices leads to loss or misplacement by the authorized user or theft by an unauthorized user.

Beyond the possible loss or theft of the validation device, other drawbacks are apparent in the prior art. In using a set or pre-set validation signal (whether electronic, magnetic, or other type), the prior art devices are not amenable to retrofitting and, further, are easily duplicated. If the signaling device is obtained or the signal is obtained from another source, an unauthorized user has access and/or control over the locked system. Also, the prior art devices are not inherently “struggle-proof”, preventing a thief from actuating or wrestling the signaling device from the authorized user. Still further, even absent a thief, using a separate signaling device normally leads to an authorized user losing or forgetting the device, thereby disabling the user from unlocking or accessing the intended object.

It is therefore an object of the present invention to provide a security apparatus that is not easily lost by or stolen from an authorized user. It is another object of the present invention to provide a security device that is easily retrofitted into existing mechanisms and systems. It is a further object of the present invention to provide a security apparatus that is unusable or effectively unusable during or after a struggle situation in which the valid user loses possession of his firearm. It is a still further object of the present invention to provide a security apparatus with a signaling device that produces a non-duplicative or non-discoverable signal, increasing the security aspect of the device.

### SUMMARY OF THE INVENTION

In order to overcome the drawbacks of the prior art, I have invented a security apparatus including a validator controller having a validator status actuator in communication with a validator receiver via a validator logic circuit. The validator receiver is configured to receive data signals, and the validator status actuator is configured to process and perform actions based upon those data signals. The present invention also includes a data transmitter, which is in contact with a human nail and in communication with the validator controller. In operation, the data transmitter transmits a data signal, the validator receiver receives the data signal, and the validator logic circuit processes the received data signal. Finally, the validator status actuator performs an action based upon the received data signal.

The present invention also includes a method of enabling or disabling an event, including: providing a validator controller having a validator status actuator in communication with a validator receiver via a validator logic circuit, the validator status actuator configured to process and perform actions based upon data signals, and the validator receiver configured to receive signals, a data transmitter in contact with a human nail and in communication with the validator controller; receiving a data signal by the validator receiver; processing the received data signal by the validator logic circuit; and performing an action by the validator status actuator based upon the received data signal.

The present invention, both as to its construction and its method of operation, together with additional objects and advantages thereof, will best be understood from the following description of specific embodiments when read in connection with the accompanying drawings.

### BRIEF DESCRIPTION OF THE DRAWINGS

FIG. 1a is block diagram of a security apparatus according to the present invention;

FIG. 2 is a block diagram of a second embodiment of a security apparatus according to the present invention;

FIG. 3 is a block diagram of a third embodiment of a security apparatus according to the present invention;

FIG. 4 is a block diagram of a fourth embodiment of a security apparatus according to the present invention;

FIG. 5 is a block diagram of a fifth embodiment of a security apparatus according to the present invention;

FIG. 6 is a block diagram of a sixth embodiment of a security apparatus according to the present invention;

FIG. 7 is a block diagram of a seventh embodiment of a security apparatus according to the present invention;

FIG. 8 is a block diagram of an eighth embodiment of a security apparatus according to the present invention;

FIG. 9 is an illustration of an electronic circuit of a nail analog chip of the security apparatus; and

FIG. 10 is a block diagram of the method according to the present invention.

### DETAILED DESCRIPTION OF THE PREFERRED EMBODIMENTS

The preferred embodiment of the security apparatus 10 of the present invention is generally shown in FIG. 1. The present invention 10 has two main elements; a validator controller 12 and a data transmitter 14. The validator controller 12 contains a validator status actuator 16, which is in communication with a validator receiver 18 via a validator logic circuit 20 (such as an embedded controller). Further, the validator status actuator 16 is configured to process and perform certain actions based upon the value or characteristics of a data signal 22. The data transmitter 14 is in contact with a human nail 24 and, in addition, the data transmitter 14 is in communication with the validator controller 12.

The human nail 24, together with conductive flesh 26 beneath the human nail 24 and a human finger 28 or toe, create a complete human nail conductive circuit 30. The capacitance value per unit of area of the human nail conductive circuit 30 is a semi-unique or individualized value, which will vary from one person to the next. In this manner, each person will have a semi-unique code or value associated with his or her unique human nail conductive circuit 30. This semi-unique value is or is translatable into the semi-unique data signal 22 and is transmitted towards the validator controller 12 by the data transmitter 14. In addition, the data signal 22 may also include from memory or from real-time measurements other unique characteristics of the user, such as nail dimension, nail curvature, nail coloration, nail groove configuration, fingerprints, operator's pulse, unique finger markings, finger opacity, an embedded unique serial number, values from a randomized area of dielectric material, values from a randomized area of resistive material, change in resistance as the user pushes against a hard surface, or a visual profile of the forefinger area, facial image, retinal image, voice characteristics, etc.

Using the total resistance formed by the conductive flesh 26 under the nail 24 between electrodes or wires is another manner in which to associate a semi-unique value to the user. If there are two or more wires through the human nail 24, the total resistance between those two electrodes is indicative of the total amount of flesh on the forefinger of the user. Also, these electrodes may be used to provide tactile feedback when a voltage is applied. If the human nail 24 is transplanted onto another person, there is a degree of likelihood that the other person will have a different amount of flesh on his or her finger, yielding a different resistance measurement range. This may be correlated with the degree of flesh discoloration under the nail due to pressure on the finger at that time to yield a more unique profile.

Further, more wires may be used to get a more detailed profile of the finger resistance. Other factors influencing finger resistance would be the ratio of flesh to bone diameter and whether pressure is being placed on the human nail 24 or on the bottom of the finger of the user. Finally, as the wires move forward on the user's human nail 24 through its natural growth rate, the resistance will slowly change in an anticipateable fashion. This may be useful in assisting in detecting a transplanted finger or the data transmitter 14 placed on an artificial conductive material. To best measure resistance with accuracy using a simple circuit, two wires can be utilized, which connect directly to the resistor (conductive flesh 26). This presents a complex time versus resistance profile as the human nail 24 grows or the finger is pushed on a solid surface. It is also envisioned that a watchdog timer may be periodically and/or sporadically used to verify that the resistance or capacitor plate's formed capacitance is in a user-specific range, and additionally, verify whether the human nail 24 has been moved or removed. An efficient manner of detecting human nail 24 removal, is a method causing decreased capacitance and increased voltage and may use a high-impedance-input voltage limiter, in parallel with the capacitor, such as a spark-gap, or MOV or specially designed ESD semiconductor device. When the capacitance decreases, the voltage increases, and the current partially discharges the capacitor.

In a struggle situation or in a situation wherein an attempt is being made to physically force a person to actuate the validator controller 12, the proximity of the attacker's finger will typically add capacitance and/or alter the data signals 22, such that the security apparatus 10 will not function. Alternatively, the security apparatus 10 may be provided with an overall timeout function where the apparatus 10 ceases to function within a predetermined time period or, possibly, an emitter may be included to “jam” an attempt to intercept communication signals within the device 10. Alternatively, the components of the security apparatus 10 may be constructed or formed such that if any attempt to move or remove them occurs, the data signals 22 are re-randomized or the device 10 is destroyed or disabled. In the event that the security apparatus 10 is damaged, destroyed or expired, an alternative means of validation may be provided. Additionally, the security apparatus 10 may be configured to “trap” the finger, hand or arm of an operator who has failed to pass the validation test.

The validator receiver receives the data signal 22 and, via the validator logic circuit 20, the data signal 22 is communicated to the validator status actuator 16. Once the validator status actuator 16 receives a data signal 22, which it verifies itself or is verified by the validator circuit logic 20, the validator status actuator 16 performs an action or conveys data based upon this received and verified data signal 22. For example, in use with a firearm, the validator status actuator 16 would enable or disable the triggering mechanism of the firearm, based upon the veracity of the data signal 22. In this instance, the validator controller 12 may be mounted on the trigger guard of a firearm.

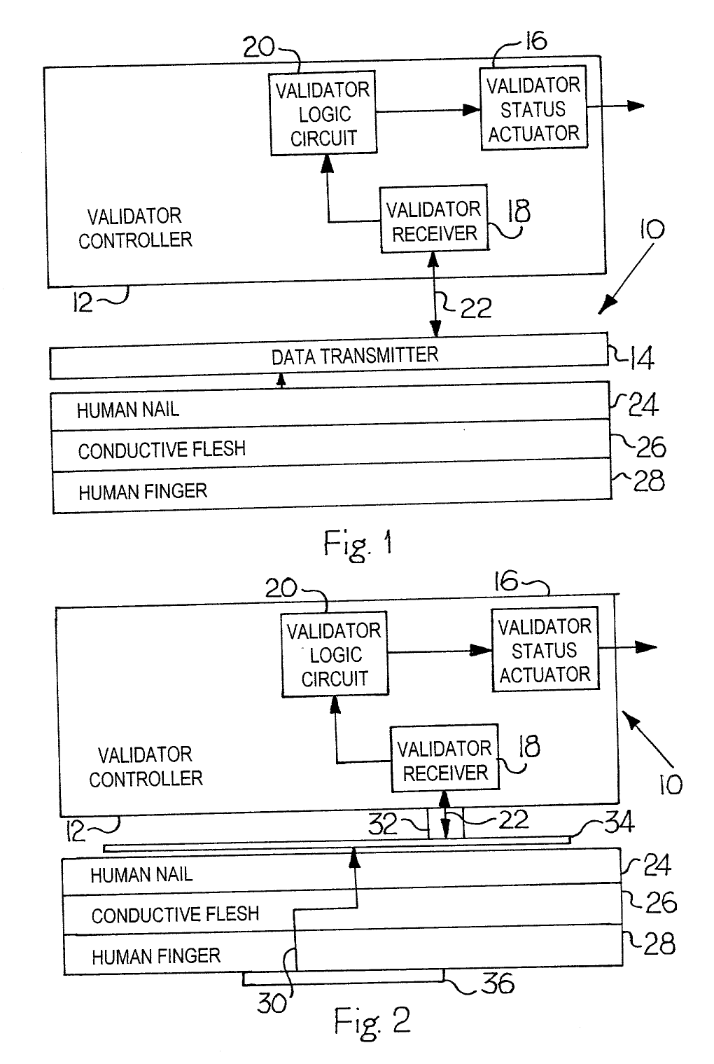

In a second embodiment of the present invention, as illustrated in FIG. 2, the security apparatus 10 further includes a direct physical connection element 32 between the validator receiver 18 and the data transmitter 14. Alternatively, the direct physical connection element 32 may be combined and integrated with the validator receiver 18. This direct physical connection element 32 may be a wire or multiple wires or other substrate which allows the data signal 22 to travel through or on it. Further, in this embodiment, the data transmitter 14 is a capacitance plate 34, which is secured directly to or in conductive contact with the human nail 24. In order to complete the human nail conductive circuit 30, a circuit return conductor 36 is provided on the human finger 28 or toe. The data signal 22 in the form of a capacitance value travels through the direct physical connection element 32 and is received by the validator receiver 18. The capacitance plate 34 may have a gold-leaf conductive coating or a gold-plated human nail 24 trimmed to specific values by trimmed area to facilitate the creation and measurement of capacitance values. In addition, the security apparatus 10 may use an array of capacitors 34 that function as a bar code. Human nail 24 modifications, such as thinning or thickening the area under just one of the capacitance plates 34, makes it more difficult to estimate another person's capacitance by measuring the thickness of their nail. This would decrease the possibility of a person attempting to duplicate the user's capacitance.

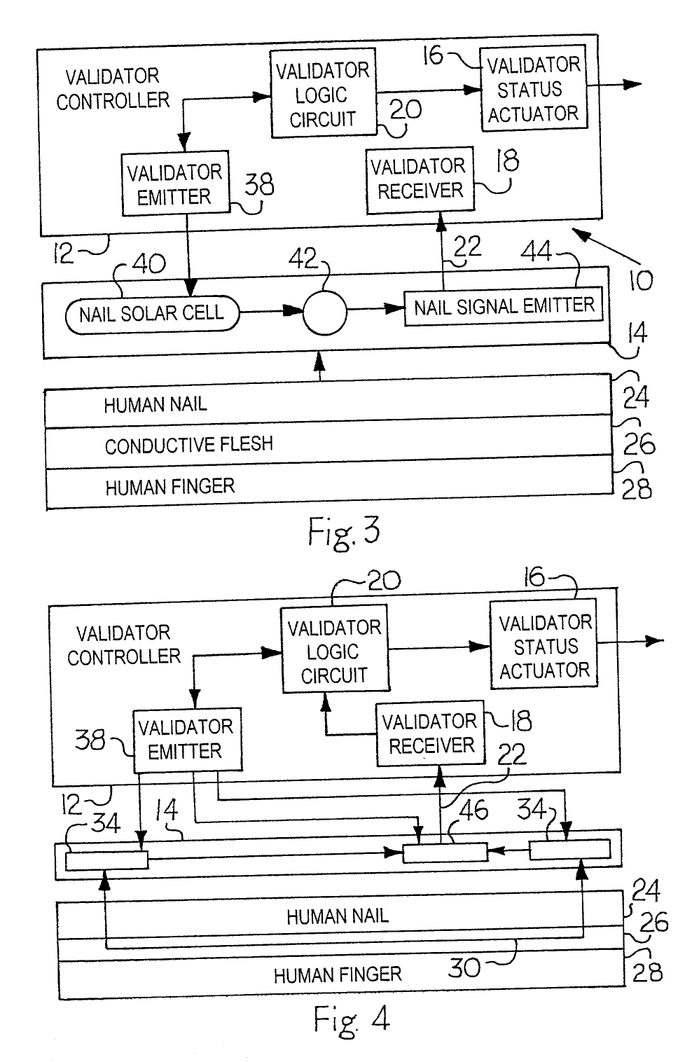

A third embodiment of the present invention is illustrated in FIG. 3. In this embodiment, the validator controller 12 further includes a validator emitter 38 configured to emit signals (such as electromagnetic waves, light, RF, infrared or ultraviolet) towards the data transmitter 14. Additionally, the data transmitter 14 includes a nail mounted solar cell 40, which receives signals, preferably light signals, from the validator emitter 38. This nail mounted solar cell 40 powers the data transmitter 14 and emits a data signal 22. Further, the nail solar cell 40 data may be replaced or supplemented with a higher speed device, e.g., a phototransistor. The data transmitter 14 also includes a nail digital chip 42, which is configured to communicate with both the nail solar cell 40 and a nail signal emitter 44 using digital logic. The nail mounted digital chip 42 receives nail-specific data from memory or the nail analog chip 48 and/or information from the nail solar cell 40 and communicates the data signal 22 to the nail signal emitter 44, which, in turn, emits the data signal 22 towards the validator controller 12. The validator receiver 18 then receives the data signal 22 and passes the data signal 22 through the validator logic circuit 20 for processing and verification for the validator status actuator 16.

Turning to FIG. 4, in the fourth embodiment of the present invention, the data transmitter 14 further includes capacitance plates 34 (as in FIG. 2) and an inductor 46, creating a resonance circuit. The inductor 46 is in communication with the capacitance plates 34, which measure the capacitance value via the creation of a specific resonant frequency through the conductive flesh 26. This unique capacitance value (or data signal 22) is transmitted through the inductor 46 and towards the validator controller 12. In order to transmit this data signal 22 to the validator receiver 18, the validator controller 12 further includes the validator emitter 38 discussed above. However, as opposed to emitting solar energy or light, the validator emitter 38 of this embodiment emits an electromagnetic wave or “pulse” towards the capacitance plates 34 and the inductor 46. In this embodiment, the inductor 46 is formed by a concentric circle of conductive material and is connected to two relatively larger areas of conductive material forming the two capacitance plates 34. The capacitance dielectric is the human nail 24, and the conductive flesh 26 is a common plate-connection for the capacitor. Other transponder-based technology may utilized to transmit the data signal 22.

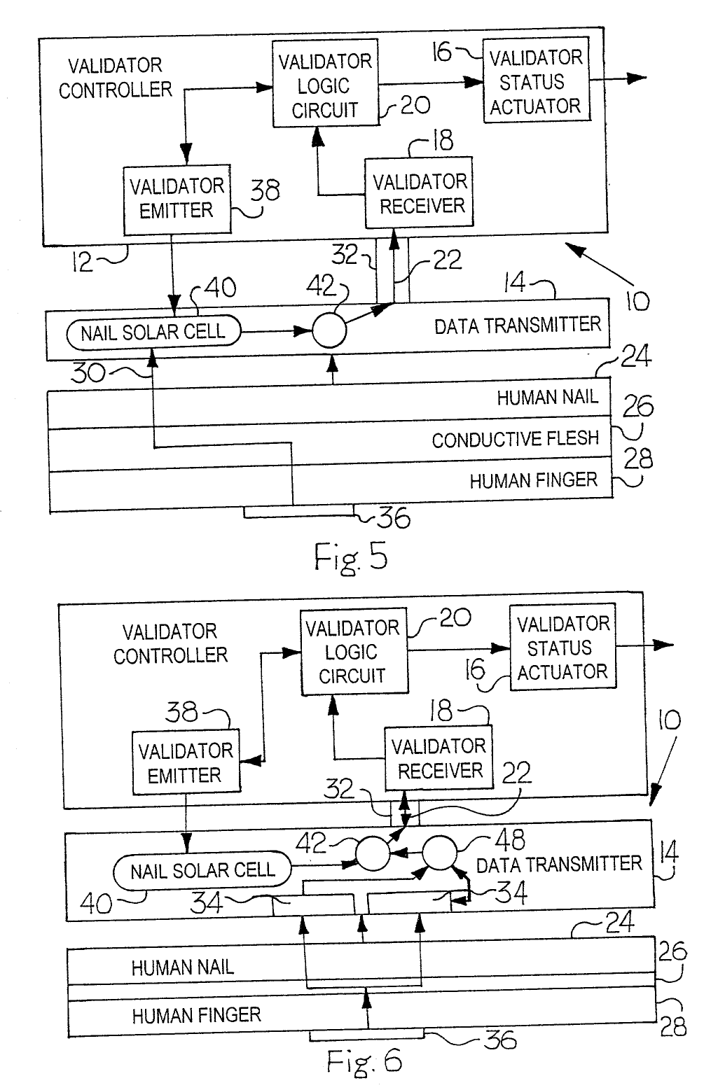

The fifth embodiment of the present invention is illustrated in FIG. 5. In the fifth embodiment, the validator controller includes the validator emitter 38, which emits an electromagnetic radiation signal to the nail solar cell 40. Using the circuit return conductor 36 on the human finger 28 or toe to complete the human nail conductive circuit 30, the nail solar cell 40 emits the data signal 22 (along with power) to the nail digital chip 42. The nail digital chip 42 transmits the data signal through a direct physical connection element 32 or contact to the validator receiver 18. As before, the data signal 22 passes to the validator status actuator 16 via the validator logic circuit 20.

In the sixth embodiment of the present invention, as illustrated in FIG. 6, the validator emitter 38 emits a signal to the nail solar cell 40, which is in communication with the nail digital chip 42 in the data transmitter 14. The data transmitter 14 further includes a nail analog chip 48 to measure the capacitance between capacitance plates 34 secured to the human nail 24 and the circuit return conductor 36 secured to a human finger 28 or toe. One embodiment of the capacitance measuring aspect of the circuit of the nail analog chip 48 is illustrated in FIG. 9. This nail analog chip 48 transmits this measured capacitance value to the nail digital chip 42, which transmits the data signal 22 through a direct physical connection element 32 to the validator receiver 18. The data signal 22 then proceeds as discussed above.

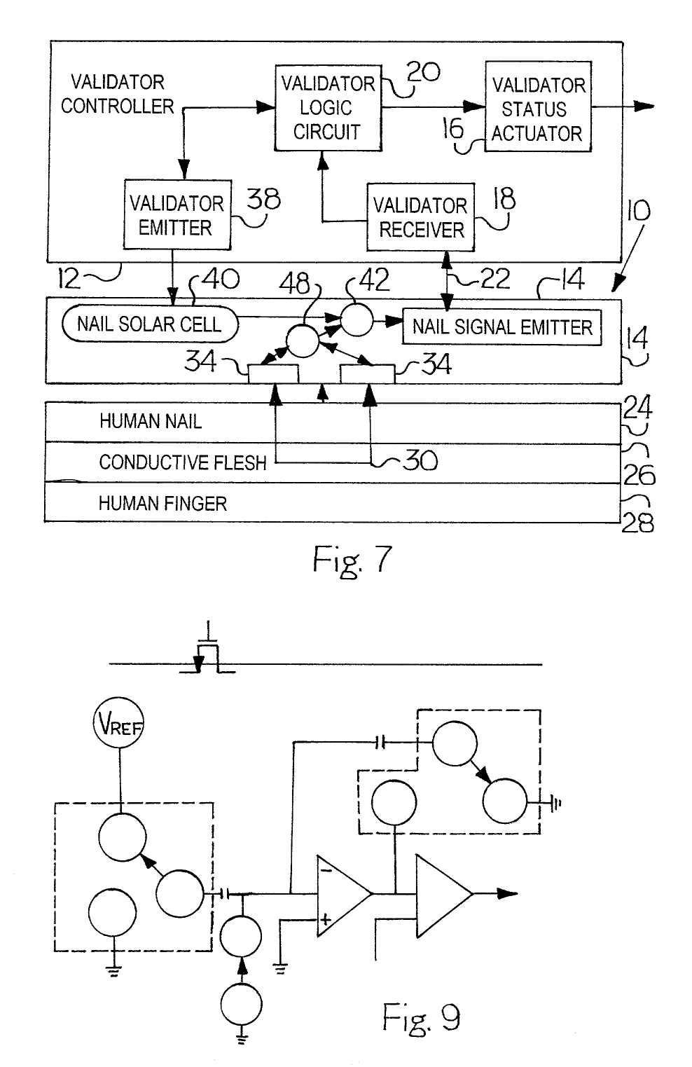

A seventh embodiment of the present invention is illustrated in FIG. 7. In this embodiment, the validator controller 12 includes a validator emitter 38, and the data transmitter 14 includes a nail solar cell 40 to receive signals from the validator emitter 38 and transmit power and signals to a nail digital chip 42. The data transmitter 14 also includes capacitance plates 34, which, as discussed above, create a capacitance value based upon the capacitance through the conductive flesh 26. The nail analog chip 48 measures this capacitance value and transmits this value to the nail digital chip 42. The nail digital chip 42 transmits this data signal 22 to the nail signal emitter 44 and, thereafter, the nail signal emitter 44 emits this signal towards the validator controller 12. The validator receiver 18 receives the signal and proceeds as discussed above. The nail analog chip 48 may utilize inductors, capacitors, resistors, semiconductors, conductors, or antennas to modify the data signals 22 emitted.

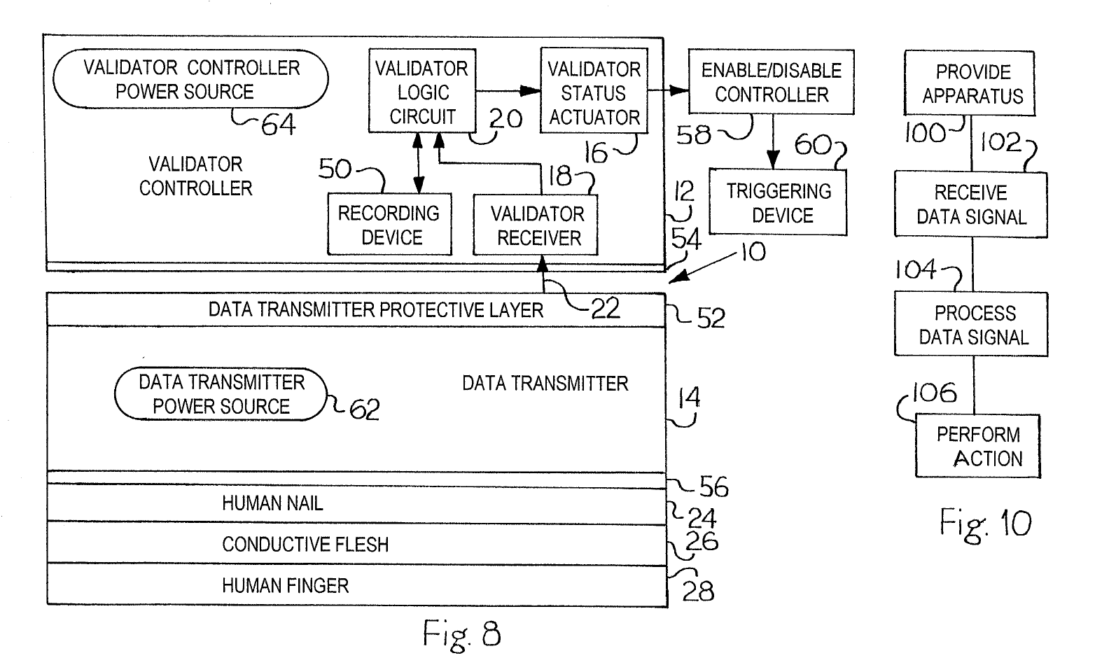

In an eighth embodiment, as illustrated in FIG. 8, the validator controller 12 may also include a recording device 50 in communication with the validator status actuator 16 via the validator logic circuit 20. This recording device 50 is configured to log specific events or conditions occurring within or outside of the security apparatus 10 and any associated devices and may be located or in communication with the data transmitter 14. For the firearm example, the recording device 50 can log the number of locking and unlocking occurrences. If the validator controller 12 or the data transmitter 14 are configured to randomly or sporadically check resistance, capacitance, temperature, pulse or other data occurrences, the recording device 50 may log the results of these occurrences. This would increase the difficulty in transplanting or attempting to transplant the data transmitter 14 onto another person or onto an artificial device designed to simulate the owner's characteristics. If an unusual reading would occur, the device may disable itself temporarily or permanently. The eighth embodiment of the present invention also includes a data transmitter protective layer 52 covering and protecting the data transmitter 14. This data transmitter protective layer 52 is formed such that it will not interfere with the communication of data signals 22 between the data transmitter 14 and the validator controller 12. Similarly, a validator controller protective layer 54 may be provided to cover and protect the validator controller 12. As with the data transmitter protective layer 52, the validator controller protective layer 54 should not interfere with any communication of signals between the validator controller 12 and the data transmitter 14.

It is envisioned that the data transmitter 14 is either attached to or in close proximity with the human nail 24. Additionally, this attachment may be temporary or permanent. An adhesive layer 56 may be utilized between the data transmitter 14 and the human nail 24. This adhesive layer 56 can be a compound which allows the data transmitter 14 to be non-permanently secured to the human nail 24. For example, using a water-based glue as the adhesive layer 56 would allow the data transmitter 14 to be removed only under running water at a certain temperature of water. This is especially valuable if there is a region of resisting compound between the nail 24 and the data transmitter 14, such that the compound resistance value is modified if the data transmitter 14 is moved or removed. The advantage of using a restricted, semi-fluid area of resistance, insulator-compound or conductor compound whose profile is established at placement time and a) whose profile remains essentially unchanged for the duration of the time the user is wearing the data transmitter and b) whose profile is based on an area of a fixed gap typically between the data transmitter and the wearer's fingernail and c) whose ‘final’ profile is established at placement time is strongly influenced by the motions of the individual placing the data transmitter onto the fingernail, and the grooves and ridges configuration under the fingernail is that if the device is removed and replaced on the same fingernail or another fingernail it is highly unlikely to return to the same profile and, hence, will influence any electrical readings based on its physical configuration.

As shown in FIG. 8, the security apparatus 10 may also be provided with an enable/disable controller 58 in communication with the validator status actuator 16. This enable/disable controller 58 can control a triggering device 60, such as a firearm trigger device or other locking mechanism, enabling or disabling the triggering device 60.

Further, the data transmitter 14 may have a data transmitter power source 62, and the validator controller 12 may have a validator controller power source 64. The validator controller 12, as well as the data transmitter 14, may have timeout periods, used to save energy during periods of non-use. These timeout periods are useable for both the situation when the data transmitter 14 and validator controller 12 have individual energy sources 62 and 64 (i.e., thermopiles, batteries, ultra capacitors, solar cells, piezoelectric elements, fuel cells, etc.) and when they do not. These timeout periods can also be combined with the watch dog timer function and recording device 50 in the data transmitter 14. It is also envisioned that the data signal 22 may be in the form of energy, electromagnetic waves, electrostatic energy or any other suitable, transmittable signal. In providing power to the data transmitter 14, two wires may be more feasible if there is no wire through the human nail 24. These two wires would typically be positive and negative to complete the circuit. Because the capacitance of the fingernail is so low, it may be less practical to provide enough alternating current through it. A typical method of supplying power is to provide a direct current circuit. This would require at least two wires, one relatively negative wire to provide a source of electrons and one positive wire to provide a means for them to return to the power source 62 or 64, allowing current to flow. If one of the wires goes to the data transmitter 14 from the validator controller 12, then a second wire through the human nail 24 allows current to proceed through conductive flesh 26 to a common metal conductor (i.e., a gun) and back to the validator controller 12, completing a current loop.

The present invention 10 also includes a method of enabling or disabling an event, as shown in FIG. 10. The method includes the steps of: providing a validator controller 12 having a validator status actuator 16 in communication with a validator receiver 18 via a validator logic circuit 20, the validator status actuator 16 configured to process and perform actions based upon data signals 22, and the validator receiver 18 configured to receive data signals 22, a data transmitter 14 in contact with a human nail 24 and in communication with the validator controller 12 (step 100); receiving data signals 22 by the validator receiver 18 (step 102); processing the received data signals 22 by the validator logic circuit 20 (step 104); and performing an action by the validator status actuator 16 based upon the received data signals 22 (step 106).

The data transmitter 14 may contain a time domain reflectometer for verification, of the individuals' identifying current paths through their flesh, around their bones, may be used as a remote controller device, may provide a user with tactile feedback, may provide a user with visual feedback by using an LCD display and may transmit the data signal 22 by modulating an LCD or a signal reflected or retroflected through a modulated LCD to a selected device, use polarization to further allow the individual to modify the signal or to act generally as a transponder. An example of tactile feedback that may be useful is a “shock”, “tingle” or vibration feedback. This tactile/shock feedback can be very useful to indicate a transaction did or did not take place. Tactile feedback may be generated by a piezoelectric element placed on the fingernail. Also, a variety of feedback pulse trains, pulse counts, strengths, combinations or even a Morse code may be useful. An external shock pulse to the operator's finger (either through wires going through the human nail 24 or at another location on the forefinger) prompts the user to respond with an intelligent action at a specific time, e.g., pushing the finger forward, down, etc. This indicates that the user is not unconscious and is not having his or her finger mechanically manipulated without his or her knowledge. The user may also respond with useful information, such as status, password, or duress code or action, including specific minor movements in the finger, which convey data used in deciding validity and/or performing an action. The validator status actuator 16 and the enable/disable controller 58 may use a solenoid, muscle wire, magnetic fluid, hydraulics, pneumatics or other suitable means to implement the desired action or convey desired data upon receipt of the verified data signal 22. Further, the security apparatus 10 may be adapted to contain additional logic to incorporate applicable secure transmission algorithms and/or encryption algorithms and/or challenge-response methods within the security apparatus 10 or between the security apparatus 10 and external devices or to the fingernail data transmitter. The individual components of both the validator controller 12 and the data transmitter 14 may be provided in separable layers. It is also envisioned that the security apparatus 10 may be adapted to detect the presence of an interposing or adjacent foreign object, such as a finger blocking the data signals 22, or detect the modification of the human nail 24 characteristics.

If the validator controller 12 has communicated with the data transmitter 14 within the last few seconds, it is reasonable to assume that a medical operation to transplant the finger, toe or human nail 24 onto someone else has not occurred in that short period of time. In this case, a more detailed and accurate (and time consuming) validation process may not be necessary. The more resolution used to measure any electrical value, including capacitance, the longer it generally takes to complete the measurement. While this may save a few milli-seconds, in a high-speed firearm trigger actuation event, the time savings may be valuable. Further, if the user has gone on vacation and the validator controller 12 has not communicated with the data transmitter 14 during that time period, it may be desired that the human nail 24 characteristics be scrutinized in greater detail. For example, the expected change in growth of the human nail 24 could be verified along with a password, blood type, fingerprint, etc. If the human nail 24 has not grown the expected amount, the possibility that it has been mounted on an artificial substrate or other substance is significant. An inherent advantage of the present invention 10 is its reliance on the human nail 24, which is a constantly growing substrate. Due to its constant growth, the human nail 24 has a variable validity period from about 0-4 months depending upon the placement location of the device. This is particularly useful in situations where the permanent right of access or use is not desired.

Some implementations of the device can be likened to an RFID device on the fingernail connected to a capacitor whose value is based on the capacitance of the user's fingernail. The value influences the RFID device's response. A disadvantage of the RFID technology is it's easier to intercept or ‘jam’ radio communications than an optical frequency based transponder. Also, it may easily interfere or be confused with or make separate simultaneous transmissions more technically difficult with other RFID devices nearby, such as on an adjacent fingernail.

A further enhancement to the device would be an electrical ground shield above the capacitor plates to isolate the plates from any capacitance variation formed between the top of the plates measuring the fingernail capacitance and a conductive area above them such as the metal body of a firearm. This would add a fixed capacitance value to the overall reading but would minimize a smaller but variable capacitance value resulting from a different positioning of the finger or a different configuration of any conductive or metallic areas in proximity to the valuator controller.

A further distinguishing characteristic between individuals is a fingernail curvature profile. It can be measured with a flat, non-conforming area of multiple plates or an array of capacitor plates glued to or positioned above the wearer's fingernail. Alternately, it can be measured by a fixed array of contacts above the surface of the fingernail. The fingernail thickness profile can be measured in a similar manner as that described above with the exception that the array of capacitive plates would roughly conform to the curvature of the nail.

The data transmitter may further incorporate a “low-power-watchdog-circuit” which would place a voltage charge on capacitor plates, typically those that measure the fingernail capacitance. The low-power-watchdog-circuit would have an electronic device whose purpose is to ‘avalanche’ or ‘short-out’ or conduct electricity if the voltage goes significantly above a value a little greater than the initial charge placed on the plates, such as a spark-gap device or specially designed ESD event or avalanche-effect semiconductor. If the fingernail or data transmitter is removed from the individual while the data transmitter is in an off or low powered state, the capacitance between the aforementioned plates would go down causing the voltage between those plates to go up and the avalanche device to conduct much of the charge away. When the data transmitter is again placed on the user or a false substrate or false user and the data transmitter wakes up for its normal watchdog timer functions, or is otherwise activated, the voltage charge across the plates will then be substantially lower than its original charge and its circuitry will detect this lower voltage and conclude the device has been tampered with while it was in the low-powered or sleep state and disable itself or erase its data preventing further unauthorized use.

Another embodiment of the data transmitter is a simple plate above or in approximate contact with the fingernail that roughly parallels it. The dimensions of the plate and the overall capacitance(s) formed (between the plate and the under-fingernail-flesh, and the distances between the plate and the under-fingernail-flesh) create a resonant circuit(s) which when energized by a device such as a microwave transmitter, resonate at specific resonant frequency(s) dependent on the components and factors mentioned above and create a microwave transponder-like device. In this embodiment, no wire is needed between the data transmitter and the validator receiver.

The device can also store information (such as when and which validator controller associated with its firearm was fired or lock unlocked or validator controller activated) in the data transmitter's fingernail digital chip 42 or simply store data from the validator controller. This can be later downloaded or read for a number of purposes including verification that the action was correctly performed. Also, other validator controllers can read this data to further test and discriminate whether the user has the authorization to perform the next action the user is requesting. An example of this would be not allowing access to a medical operating room unless the user recently entered a decontamination room. It is also recognized that some applications may require negotiation or a ‘conversation’ between the data transmitter and the validator controller such as an exchange of passwords. Another example would involve unlocking access to a room with a specific level of toxic gas such as carbon monoxide that is determined to be below the wearers calculated accumulated daily threshold of safe toxic concentration which only the data transmitter would know.

The device works symbiotically with a fingerprint reader. Since the device can store data such as a person's identification, expected fingerprint pattern, and other security or authorization or classification, it enables a fingerprint reader which is ‘unfamiliar’ with this new set of prints to validate that the individual whose prints it belongs to is authorized or belongs to a category of people authorized to gain access, perform functions, etc. Combined with a fingerprint reader, the resulting device also can decrease the fingerprint reader's error rate of false positives or false negatives.

The data transmitter can be configured to receive and transmit signals not only to a validator controller above the nail or at a significant distance from the nail, but also to a validator controller underneath the finger or using the finger flesh as a light or electromagnetic energy conducting conduit. A good application of this would be used with push-button switches which would have a validator controller built into them or connected to them via a fiber-optic link allowing the smart switch to verify the identification of the user and his validity before allowing the switch to perform the requested action. A fingerprint reader on switches would be too slow, large, unreliable and costly to implement efficiently.

The data transmitter and its fingernail digital chip 42 can store or exchange messages or data with validator controllers and run programs internal to it for security verification of validator controllers, data logging purposes and/or timing purposes, etc. For example, the data transmitter may calculate in its fingernail digital chip 42 that the wearer should not be allowed access into an area of hazardous gas until two hours after leaving another such area.

The data transmitter can further incorporate a microphone to recognize its wearer's voice and voice commands to change its state or authorize it to release or make available specific categories or areas of information to the validator controller requesting that information be made available to the next validator controller to be read. Examples of this would be medical records, or specific credit information. Voice commands may instruct the performance of operations on stored, current or future data such as perform select and calculate only on dental, medical or financial transaction. Alternately, a simpler use of a microphone interface is to signal the wearer's intentions to the data transmitter to recognize the sound of the user ‘snapping his fingers’ to indicate a specific desired state change.

The data transmitter can further incorporate a small fingerprint reader or keypad into its top surface such that an individual can pre-authorize his data transmitter to release information only by briefly placing a preselected digit of another of his fingers or sequence of his fingers over the top of his data transmitter and the data transmitter recognizing it as his digits and authorization request by comparing it with a pre-stored configuration of his fingerprints. Once the pre-authorization is complete, the data transmitter may then release the data requested to the validator controller when prompted by the validator controller. Other sequences of individual's fingerprints read may further allow the individual to issue commands to the data transmitter such as ‘alarm me’ if any data of a personal/financial category is requested by a validator controller before releasing said data.

The value of multiple fingernails with a data transmitter on each of them is the following: it allows for redundancy in the event one falls off, malfunctions or becomes invalid due to fingernail growth causing capacitors to extend beyond under-fingernail-flesh and drastically changing their value. An example would be while on an extended vacation. It allows for different levels, categories, or amounts of information to be stored and consciously selected by the wearer and offered to the validator receiver. For example one worn only on the small finger may only validate the user's name and address whereas one worn on the middle finger may have financial information available to a validator controller. The wearer would also be able to carry or have available more total data and functions.

If the solar receiver cell operates at the light energy area of the spectrum and not the RF area, it can also use ambient light to recharge a power source or battery in the data transmitter, especially during periods it is not being used to communicate with the validator controller. This power may be used for other purposes such as periodic and/or sporadic watchdog timer checks of wearer's pulse rate and/or capacitance and/or amplifying or boosting the signal later to the validator receiver to allow it to operate over greater distances.

A small transparent keypad may be placed on top of the data transmitter to enable the wearer to enter codes to change the state of or to authorize the data transmitter to release or make available specific categories or areas of information to the validator controller requesting it. For example, that information might include medical records or specific credit card numbers.

A further safety mechanism can be introduced wherein using a simple breakable link (circuit with a wire going from data transmitter to the nail where it is glued and back to data transmitter or a switch or the continuous sensing for a correct capacitance value) a data transmitter removal can be detected. In the event the data transmitter falls off the wearer or is removed without pre-authorizing the removal, the data transmitter erases or disables its own data from being transmitted.

It should be noted that the fingernail is the closest, most useable area of the fingertip which is also the area of the body fastest and most varied in motion and states. Hence, it is most able to communicate those states to the device mounted on the fingernail to a validator controller, switch or the outside world.

A further enhancement would be to provide a means to tune or adjust an ‘adjustment-constant’ which is later added to the capacitative value and would be useful when replacing a data transmitter so no revalidation/re-introduction is needed. A special replacement security state would be useful to prevent this feature being used for falsification or tampering. Therefore, a method of eliminating the need for a reintroduction phase after the data transmitter is removed and replaced onto the fingernails to send a ‘special’ secure control signal to the data transmitter along with a trimming or adjustment value to be added to the raw real-time capacitance value so that the new resulting value of capacitance sent to the validator controller will be identical or close enough to the old capacitance that the data transmitter device doesn't need to be reintroduced to the validator controller to re-recognize the individual and perform the desired action. Alternatively, a secure “accept this new value as correct and adjust you constants accordingly” signal may be used to do this. This enables the new position of the data transmitter to be recognized by another stand alone validator controllers afterwards.

Another enhancement would be to use an acoustic wave pulse created by an ultrasonic transducer which can be sent through the fingernail into the flesh under it or along the fingernail and read back to further verify nail thickness and/or verify there is no unauthorized artificial object under the fingernail which might be used in an attempt to create an artificial fingernail flesh. It can also be used to verify the other dimensions of the nail, i.e. width and length, etc.

It should be noted that the device measures a resultant capacitance formed by the area(s) of the plates, any conductive adhesives, any insulating adhesive compounds, any other interacting structures such as electrostatic shielding, an aggregate measurement effected by the individual's grooves and the dielectric constant of the wearer's fingernail and does not necessarily always measure the wearer's fingernail thickness.

The individual's fingernail groove configuration can be read by placing an array of electrodes on top of a resistive compound, with said compound filling the valleys and still covering the peaks of the fingernail grooves, such that the resistance read between the electrodes is thus being influenced by the depth and position of the fingernail grooves and peaks.

Additionally, if the plates are glued to the nail, (as is done in the preferred embodiment) the glue will and should have a different dielectric constant than the individual's nail and the groove dimensions and ridge dimensions as well as the thickness of the glue layer over top of all the ridges will influence the overall resulting capacitance measurement and may add a physical randomizing factor at application or re-application time.

An accelerometer can also be used to read finger motions and convert and interpret them as commands to the data transmitter logic chip or validator controller instead of or in addition to pressing the finger flesh in such a manner as to cause under the nail discoloration or using a keypad or other means for the wearer to issue commands or data to his data transmitter chip.

It is also recognized that the validator receiver can or may be built into or fabricated on the same chip as the validator logic circuit, depending on semiconductor fabrication advances and economic feasibility and they then can be considered as one component.

Although not limiting, the present invention 10 is particularly useful with trigger-operated tools, storage units, locking mechanisms, software-logic keys, personal identification systems, credit validation systems, computer access, fund transfers and other e-commerce transactions, authorized access situations, third-party information transactions, transportation and travel transactions, Internet transactions, pharmaceutical transactions, licensing, registration, visa and passport transactions, etc.

In a specific example, the validator controller 12 is mounted on a trigger guard of a firearm in front of the trigger. The enable/disable controller 58 is a solenoid slide release mechanism installed and adjusted to be both behind the firearm trigger at the trigger's nearest and furthest points of motion. The triggering device 60 is the firearm trigger mechanism. The data transmitter 14 is glued to the individual's fingernail.

Capacitance plates 34, which are in contact with the human nail 24, form a measurable specific and individualized capacitance (approximately 1,000-25,000 picoFarads), depending upon the individual's fingernail characteristics (e.g., thickness) and the location and area of the capacitance plates 34. A typical capacitance plate 34 may be approximately 5 mm² in area. The capacitance plates 34 are connected to the inductor 46 to form a resonant circuit.

Next, a key is inserted into the validator controller 12, and the individual places his or her finger on the firearm trigger, pushing his or her finger to engage a pushbutton switch, powering the security apparatus 10. The validator logic circuit 20 causes a pulse generator in the validator emitter 38 to power the data transmitter 14, capacitance plates 34 and inductor 46 (resonant circuit). This resonant circuit “rings” or oscillates at a specific frequency determined by the value of the inductor 46 and the capacitance of the human nail 24. This frequency or data signal 22 is received by the validator receiver 18, and the exact frequency in MHz is counted by the validator logic circuit 20 and converted to an 8-bit-36-bit binary number. The validator logic circuit 20 then stores the frequency value in Flash memory PROM in the validator logic circuit 20, which is typically an 8-bit MPU, such as a Motorola MC6811 or a Microchip PIC-based MPU. The key is then removed, and the individual is ready to use the security apparatus 10. Further, the security apparatus 10 powers itself down automatically after 10 minutes of operation without a signal being received by the validator receiver 18. Alternatively, the individual powers down the unit 10 by re-engaging the same push-button switch.

Using the device of this specific example, the individual places his or her finger on the firearm trigger and pushes forward his or her finger to engage a push-button switch, which switches on the power to the validator controller 12. The validator controller 12 uses the same method described above to measure the capacitance or resultant resonant frequency of the human nail conductive circuit 30, and if the value falls within a small percentage range of the value of the initially-introduced frequency value (stored in the validator logic circuit 20 Flash PROM), the validator logic circuit 20 sends current through a solenoid to release the trigger lock mechanism, allowing the trigger to be actuated. The validator controller 12 may also “beep”, light a light, vibrate slightly or, at the individual's discretion, indicate to the individual that the firearm is ready for use. The validator controller 12 may also indicate how close the validator controller 12 is from deciding the validity of the individual's current capacitance value, possibly requiring recalibration or re-introduction.

The individual typically performs this action at the beginning of the day to verify continued validation later in the day. The individual would also perform the same procedure to actually fire the firearm, with the exception of releasing the firearm's mechanical safety mechanism. In a non-retrofitted situation, the safety would be wired to the validator controller 12, and the safety would switch power to it and have two positions; one to test the validator controller 12, and a second position to mechanically release the firing mechanism to ready the firearm.

In another specific example, wherein the validator controller 12 is mounted on a firearm, a key is inserted into the validator controller 12 and the individual places his or her finger on the firearm trigger and pushes his or her finger forward to engage a push-button switch. The push-button switch powers the validator controller 12 and releases a validator contact spring, allowing it to push forward against the person's fingernail. In this example, the validator contact spring is the direct physical connection element 32. The validator contact spring is gold plated and contacts a large area of gold leaf glued to the individual's fingernail. The validator controller can now read and record the capacitance formed by the gold leaf plate, the individual's fingernail and the conductive flesh underneath the fingernail. This capacitance can be measured by many methods, such as using a switched capacited circuit (having CMOS mixed signal integration) to measure the specific capacitance value. An advantage of this method is that, at these low capacitance values, the lower the capacitance, the less current and hence power is required to perform the measurement. The resulting value is then stored in the Flash PROM in the validator logic circuit 20, typically an 8-bit MPU with Flash or EEPROM non-volatile memory, such as a Motorola MC6811 Series Processor. The key is then removed, and the individual is ready to use the device 10. The security apparatus 10 powers itself down automatically after 10 minutes of operation without a “reasonable” amount of capacitance being measured, indicating the absence of an individual's finger. Alternatively, the individual powers down the unit by re-engaging the same aforementioned push-button switch.

In operation, the user places his or her finger on the firearm trigger and pushes forward his or her finger to engage a push-button switch, which switches on the power to the validator controller 12 and releases the validator contact spring, allowing it to push forward against the fingernail. The validator controller 12 uses the same method described above to measure the capacitance of the individual's human nail conductive circuit 30, and if the capacitance falls within a small percentage range of the value the individual initially introduced in the previous phase, the validator logic circuit 20 sends current through a solenoid to release the trigger lock mechanism, allowing the trigger to be pulled.

A desirable, but slightly less accurate method of forming and reading the individual's fingernail capacitance characteristic is to use a flexible, spongy, rounded-rectangular or oval-shaped conductive area surface of approximately 3 mm by 5 mm, at the end of the conductive spring, which may conform to the shape of the surface of the human nail 24. This method does not require a gold leaf or any other semi-permanent discoloration or coating on the fingernail. The conductive spring contacts the surface of the fingernail and replaces the semi-permanent capacitor plate normally painted or glued on. Choosing a larger size would further prevent children from using the firearm, because the spongy-plate would contact the flesh on the sides of their considerably smaller finger and would be easily detectable. Upon contact, in this situation, the capacitor would completely “short out”. Also, due to a significantly thinner fingernail thickness, a child's capacitance would be significantly higher and would be rejected as out-of-range in the initial introduction phase discussed above.

In yet another specific firearm example, the data transmitter 14 is glued to the individual's fingernail. Capacitance plates 34 are integrated with the data transmitter 14 and are positioned close or in contact with the fingernail to form a measurable specific and individualized capacitance. This specific and individualized capacitance depends on the individual's fingernail characteristics, especially their fingernail thickness, size of their fingernail and the size and location of the capacitance plates 34. As before, a key is inserted into the validator controller 12 and the individual places his or her finger on the firearm trigger and pushes forward to engage a push-button switch and power LEDs in the validator emitter 38, which illuminates and powers the nail solar cell 40 and the data transmitter 14 circuitry. The fingernail solar cells send power to the nail digital chip 42, which has a low-voltage CMOS mixed signal integration-based switched capacitor circuit. The nail digital chip 42 is dedicated to measuring the fingernail capacitance (formed in a capacitance range of 0-25 picoFarads on the finger) using common charge transfer switching sequences similar to those found in low-power A/D converters, and converting that capacitance measurement value to an 8-bit to 24-bit binary number. This binary number, combined with other data, e.g., checksum and serial number, are approximately 60-bits total in the nail digital chip 42. This communication occurs in serial binary fashion through a shift register clocked at typically 200 KHz to an IR emitter LED, which then illuminates the validator receiver 18 (also infrared). The validator logic circuit 20 gets this CMOS-voltage level digital data from the validator receiver 18, verifies the checksum or CRC code, matches the sent capacitance value, and stores the fingernail digital chip 42 serial number and the fingernail capacitance measurement in the Flash memory PROM in the validator logic circuit 20. The key is then removed and the individual is ready to use it. In operation, this example of security apparatus 10 functions as described above.

In this manner, the present invention 10 is not easily lost by or stolen from an authorized user. Further, the present invention is a security apparatus 10 that is easily retrofitted into existing mechanisms and systems. Also, the security apparatus 10 is unusable or effectively unusable during or after a struggle situation in which the valid user looses possession of his firearm. In addition, the present invention 10 provides a signaling device that produces a substantially non-duplicative or non-discoverable signal, increasing the security aspect of the device 10.

The embodiments of my invention which requires no permanently mounted device on the fingernail have numerous advantages over prior security devices. These include the following: it is inherently capable of being the fastest, least expensive, smallest, most unobtrusive, ergonomic, most rugged, lowest-power biometric device available. It uses little data storage as opposed to retinal or fingerprint biometric devices, which can typically use a megabyte or more. It is less objectionable than a fingerprint identification device to individuals who dislike business or government collecting personal data. It combines well (no effect on speed of operation) with a fingerprint reader. It can incorporate or be combined with a hidden machine randomized finger tactile-generation-response mechanism which allows verification that a fingerprint hasn't been fabricated or sliced off the individual identified. It leaves no lingering individual data such as a fingerprint. It is small enough to build into a smart card. It discriminates between small children and adults as categories. It inherently has ease of redundancy, i.e. other finger's fingernails can be identified and used as a backup. It is located at a human ‘decision-point’ where intentions are expressed through actions at the tip of the finger. It is a struggle-situation sensitive, i.e., it is more difficult to force an unwilling wearer to perform a verification action than most other biometric devices. It can easily combine multiple devices on multiple fingers for tighter security (up to 10 times). It is extremely difficult to unknowingly or clandestinely read as opposed to other biometric devices. It is especially compatible with firearms. It combines well with a password or pin. If the password is observed, it offers another layer of protection. It is difficult to steal. It requires no user memorization. It has an inherent, built-in physiological, adjustable-selectable expiration period.

The embodiments of my invention requiring a permanently mounted device on the fingernail also have numerous additional advantages. These include the following: it can be no-contact, and hence sanitary. It can be read/transmitted at a distance. Due to its low power nature, it can continuously verify the identification of the wearer without affecting the daily activities of the wearer, so even a very sophisticated and brief period of attempting to transfer physical or biometric characteristics to another is detectable. It has a small interface point, therefore, the reader is suitable for interfacing with switches. It allows immediate verification and/or identification while controlling a device such as pressing a switch or operating a device. It is capable of getting instructions, data or information from the wearer. It can easily exchange data with a wearer who is blind or in darkness. It requires a minimum amount of movement to exchange data. It is capable of issuing feedback or data to wearer quickly and invisibly. It is capable of storing data and executing programs including encryption/security programs from an authorized reader. It is capable of exchanging data with readers over a distance. It is capable of allowing the wearer to quickly select other reader-devices) to exchange data, actuate or control devices. It can be read sporadically, periodically or continuously by the reader without requiring any additional wearer effort, time or difficulty. For example, a continuous remote read near a computer keyboard to verify an authorized user is using the licensed software. With a speckled randomized ‘confetti coating’, it can present an additional level of security.

The security devices disclosed herein have many uses. In the case of those that rely solely on the properties of the human nail and the finger and its surrounding areas the following uses include:

MAC machines with or in place of PIN number;

child-exclusion locks, for example, childproof vending machines;

locks for children only, for example, household back door locks that only a child's small finger's fingernail can open;

an appliance on/off/state switch, for example, if a child turns on a TV equipped with this device, it limits access to TV channels appropriate for children;

fast, cheap, low security locks;

bike locks built into a bike;

briefcase or luggage locks;

beach or cabana locks;

temporary public locks, for example, gym lockers or Laundromats;

quick change or quick access locks, for example, for apartments or hotel rooms;

public lockers, for example, the user puts a quarter in and inserts his finger to re-recognize his identity to the device which then opens to give him access to his belongings;

standalone padlocks, locks or childproof locks;

a hotel room safe lock, which doesn't require the user to establish or remember a combination number;

a firearm trigger lock; and

military or prison locks that owe value to the device's ruggedness and easily configured ability to trap unauthorized user's finger.

The use of the security devices disclosed herein which require a permanently mounted device on the nail is not limited to but include the following:

used as an ultra-secure lock;

used as a software user validation lock to prevent unauthorized people from using or copying and using commercial software;

used as an individual identification device which identifies who is pressing, controlling or actuating a switch such as in industrial or military application;

as an accidental switch actuation inhibitor;

used for credit card, ecommerce or banking transactions;

used as a continuous biometric based encryption/decryption key generation and/or verification device for data copy protection or playback authorization;

used as a means of securely identifying an individual; and

used as one or many remote control devices.

This invention has been described with reference to the preferred embodiments. Obvious modifications and alterations will occur to others upon reading and understanding the preceding detailed description. It is intended that the invention be construed as including all such modifications and alterations.

I claim:

1. A security apparatus, comprising:
a validator controller having a validator status actuator in communication with a validator receiver via a validator logic circuit, the validator status actuator configured to process and perform actions based upon data signals, and the validator receiver configured to receive data signals;
a data transmitter in contact with a human nail and in communication with the validator controller; and
said data transmitter relying upon the physical properties;
wherein the data transmitter transmits a data signal, the validator receiver receives the data signal, the validator logic circuit processes the received data signal, and the validator status actuator performs an action based upon the received data signal.

2. The security apparatus of claim 1, further comprising:
a direct physical connection element between the validator receiver and the data transmitter;
wherein the data signal is transmitted through the direct physical connection element.

3. The security apparatus of claim 2, wherein the data transmitter comprises:
a capacitance plate secured to the human nail; and
a circuit return conductor.

4. The security apparatus of claim 1, further comprising a data transmitter power source powering the data transmitter.

5. The security apparatus of claim 1, further comprising a validator controller power source powering the validator controller.

6. The security apparatus of claim 1, wherein the validator controller further comprises a validator emitter configured to emit signals towards the data transmitter.

7. The security apparatus of claim 6, wherein the data transmitter further comprises:
a nail digital chip configured to communicate with the validator receiver; and
a nail solar cell configured to receive signals from the validator emitter and power the data transmitter.

8. The security apparatus of claim 7, further comprising:
a direct physical connection element between the validator receiver and the data transmitter;
wherein a data signal is transmitted through the direct physical connection element.

9. The security apparatus of claim 9, wherein the data transmitter further comprises:
at least one capacitance plate secured to the human nail and configured to communicate with the nail analog chip; and
a circuit return conductor.

10. The security apparatus of claim 8, wherein the data transmitter further comprises a nail analog chip in communication with the nail digital chip.

11. The security apparatus of claim 7, wherein the data transmitter further comprises a nail signal emitter configured to emit data signals towards the validator receiver.

12. The security apparatus of claim 11, wherein the data transmitter further comprises a nail analog chip in communication with the nail digital chip.

13. The security apparatus of claim 12, wherein the data transmitter further comprises at least one capacitance plate secured to the human nail and configured to communicate with the nail analog chip.

14. The security apparatus of claim 6, wherein the data transmitter further comprises at least one capacitance plate secured to the human nail.

15. The security apparatus of claim 14, wherein the data transmitter further comprises an inductor in communication with the at least one capacitance plate and configured to emit data signals towards the validator receiver.

16. The security apparatus of claim 1, further comprising a recording device, the recording device configured to log specific events occurring within the security apparatus and associated devices.

17. The security apparatus of claim 1, further comprising:
a data transmitter protective layer covering and protecting the data transmitter;
wherein the protective layer does not interfere with communication of data signals between the data transmitter and the validator controller.

18. The security apparatus of claim 1, further comprising:
a validator controller protective layer covering and protecting the validator controller;
wherein the protective layer does not interfere with communication of data signals between the data transmitter and the validator controller.

19. The security apparatus of claim 1, further comprising an adhesive layer between the data transmitter and the human nail, the adhesive layer configured to non-permanently secure the data transmitter to the human nail.

20. The security apparatus of claim 1, wherein the validator status actuator communicates with an enable/disable controller, the enable/disable controller in communication with a triggering device and configured to enable or disable the triggering device.

21. A method of enabling or disabling an event, comprising the steps of:
providing a validator controller having a validator status actuator in communication with a validator receiver via a validator logic circuit, the validator status actuator configured to process and perform actions based upon data signals, and the validator receiver configured to receive signals, a data transmitter in contact with a human nail and in communication with the validator controller;
receiving a data signal by the validator receiver;
processing the received data signal by the validator logic circuit; and
performing an action by the validator status actuator based upon the received data signal.

22. The apparatus according to claim 1, wherein the physical properties of the nail relied upon by the data transmitter are selected from the group electrical, magnetic, ultrasound responsive properties, tactile, electromagnetic naturally or artificially occurring, created or modified properties and its surroundings.
